(19) United States
(12) Patent Application Publication
(10) Pub. No.: US 2017/0134651 A1
(43) Pub. Date: May 11, 2017

(54) Portable Device for Generating Wide Angle Images

(71) Applicants: Mei-Ling Lo, New Taipei City (TW); Kuo-Ching Chiang, New Taipei City (TW)

(72) Inventors: Mei-Ling Lo, New Taipei City (TW); Kuo-Ching Chiang, New Taipei City (TW)

(21) Appl. No.: 15/410,785

(22) Filed: Jan. 20, 2017

Related U.S. Application Data
(63) Continuation-in-part of application No. 14/258,023, filed on Apr. 22, 2014.

(30) Foreign Application Priority Data
Apr. 18, 2016 (TW) 105112100

(51) Int. Cl. H04N 5/232; G06F 3/0346; G02B 13/06; H04N 5/247

(52) U.S. Cl. CPC H04N 5/23238; H04N 5/247; H04N 5/23293; G06F 3/0346; G02B 13/06; G06F 3/0488

(57) ABSTRACT

A portable device includes a control unit; a first and a second image capturing device coupled to the control unit; a wide angle image generating module coupled to the control unit to activate the first and the second image capturing device, simultaneously for taking a first picture by the first image capturing device and a second picture by the second image capturing device respectively; a stitching module coupled to the control unit to combine the first picture and the second picture to form a wide view angle image; and a display coupled to the control unit for displaying the wide view angle image.

### CROSS-REFERENCE TO RELATED APPLICATIONS

The present application is a continuation-in-part application of U.S. patent application Ser. No. 14/258,023 filed on Apr. 22, 2014, and a counterpart foreign application of TAIWAN Patent Application Serial Number 105112100 filed on Apr. 18, 2016, which are incorporated herein by reference in their entirety.

### TECHNICAL FIELD

The present invention generally relates to a portable device, and particularly to a portable device for generating wide angle images.

### DESCRIPTION OF RELATED ARTS

In pace with the development of IT (information technology), information can be exchanged with higher speed and greater capacity. The third generation mobile protocol can make users enjoy diverse services, and immediately information exchange is executable such that live broadcast can be watched via the mobile communication internet or the Internet. All of the portable devices employed a so called front camera to capture the selfie or self-image. A selfie is a type of self-portrait photograph, typically taken with a hand-held digital camera or camera phone. Selfies are often casual, and are typically taken either with a camera held at arm's length or in a mirror. The front camera is typically set at the same side with the display, and a rear camera is set back of the display to take a picture. However, neither in common knowledge nor in the arts, it is unlikely for a user to take a picture with the desired background when takes the selfie.

### SUMMARY

The present invention provides a portable device, including: a control unit; a first and a second image capturing device coupled to the control unit; a wide angle image generating module coupled to the control unit to activate the first and the second image capturing device, simultaneously for taking a first picture by the first image capturing device and a second picture by the second image capturing device respectively; a stitching module coupled to the control unit to combine the first picture and the second picture to form a wide view angle image; and a display coupled to the control unit for displaying the wide view angle image.

In another aspect, the present invention provides a portable device, including: a control unit; a front and a rear image capturing device coupled to the control unit; a wide angle image generating module coupled to the control unit to activate the front and the rear image capturing device, simultaneously, for taking a first picture by the front image capturing device and a second picture by the rear image capturing device respectively; a stitching module coupled to the control unit to combine the first picture and the second picture to form a wide view angle image; a display coupled to the control unit for displaying the wide view angle image; and a gyroscope coupled to the control unit for controlling a display angle of the wide view angle image.

In still another aspect, the present invention provides a portable device, including: a control unit; a first and a second image capturing device coupled to the control unit; a wide angle image generating module coupled to the control unit to activate the first and the second image capturing device, simultaneously, for taking a first picture by the first image capturing device and a second picture by the second image capturing device respectively; a stitching module coupled to the control unit to combine the first picture and the second picture to form a wide view angle image; and a display coupled to the control unit for displaying the wide view angle image, wherein the wide view angle image includes angle information, time information or the combination thereof.

According to one aspect of the present invention, the first and the second image capture device may include CMOS or CCD. According to one aspect of the present invention, the step of adjusting the first or second picture may include size enlarging, squeezing, image rotating, translating, swapping left and right, trimming, color fading, blurring, smoothing, noise reduction.

According to another aspect of the present invention, a short range wireless internet module can be further included, which comprises Wi-Fi module, or 802.11x (x=a, b, g, n) module, wherein a WiMAX (Worldwide Interoperability for Microwave Access) module can also be introduced.

The portable device may further comprise a multi-tasking module coupled to the control unit, and a display segmentation unit coupled to the control unit to divide the display into at least two areas to display a receiving image captured by the self-image generating module.

### BRIEF DESCRIPTION OF THE DRAWINGS

FIG. 1 shows a diagram of one embodiment of the present invention.

FIG. 2 shows a diagram of another embodiment of the present invention.

FIG. 3 shows a diagram of yet another embodiment of the present invention.

FIG. 4 shows a diagram of one embodiment of the present invention.

FIG. 5 shows a diagram of still another embodiment of the present invention.

FIG. 6 shows a diagram of yet another embodiment of the present invention.

### DETAILED DESCRIPTION

In the following paragraphs, some sample embodiments of the invention will now be described in greater details. Nevertheless, it should be recognized that the present invention can be practiced in a wide range of other embodiments besides those explicitly described, and the scope of the present invention is expressly not limited expect as specified in the accompanying claims. The present invention can be integrated in the device such as a mobile phone, a digital video camera, a digital camera, a PDA, a smart phone, a GPS, a digital photo frame, or a notebook, etc.

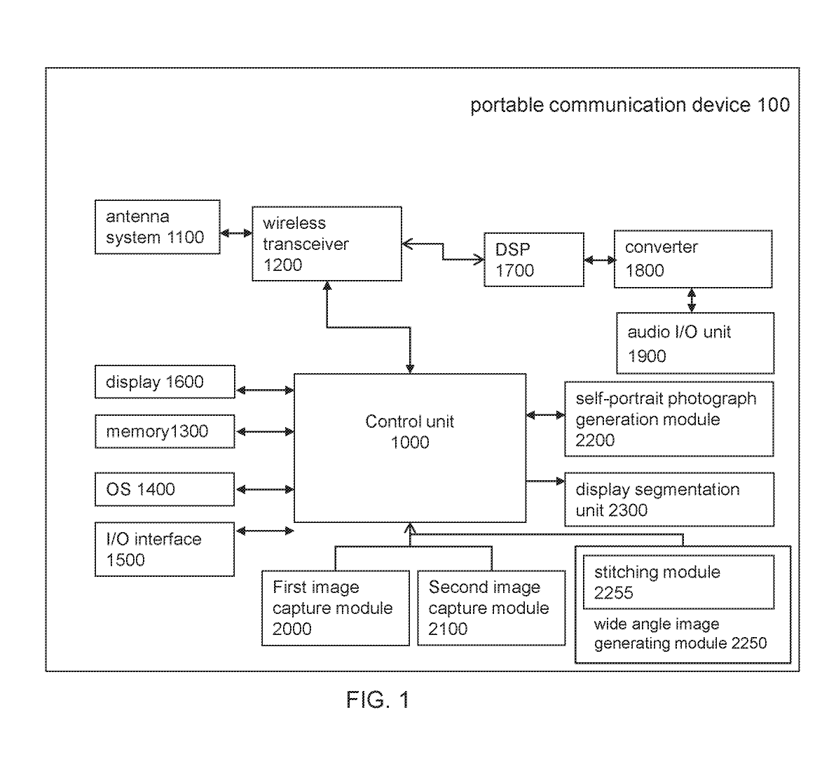

FIG. 1 exhibits a diagram of the portable communication device 100 in accordance with one embodiment of the present invention. In this embodiment, the portable communication device 100 includes a wireless transceiver 1200, which can be a RF module for transmitting or receiving mobile signals. As well known by the person having ordinary skill in the art, the RF module is coupled to an antenna system 1100 which may be single or multiple antennas according to demands, and RF module may further include the base band processor. The antenna system 1100 is connected to a radio transceiver 1200 for transmitting or receiving signals. The wireless radio transceiver 1200 is compatible with various mobile communication protocols, such as W-CDMA, CDMA2000, CDMA2001, TD-CDMA, TD-SCDMA, UWC0136, DECT, or 4G systems. These systems allow users to communicate through video telephone. The RF module may be introduced to perform transmitting and receiving of signals, frequency synchronization, base band processing, and digital signals processing, etc. The portable communication device 100 may include a DSP (digital signal processor) 1700 and/or a central control unit 1000, encoder/decoder (not shown) and analog/digital(A/D) converter 1800, and the arrangement of those elements can be determined based on applications. The signals can be transmitted to the final actuators, that is, the audio I/O (input/output) unit 1900 via the DSP 1700 and the analog/digital converter 1800.

The portable communication device 100 further comprises a display 1600 to display application user interface and information, OS (operation system) 1400, and memory 1300, wherein the memory 1300 includes nonvolatile FLASH memory. Aforementioned units can be coupled to the central control unit 1000 respectively or the DSP. The USB I/O interface 1500 is coupled to the central control unit 1000. The portable communication device 1000 may also include anther wireless transceiver such as WiFi or 802.11x (x refers to a, b, g, n), and the users can connect internet or hot spots via WiFi.

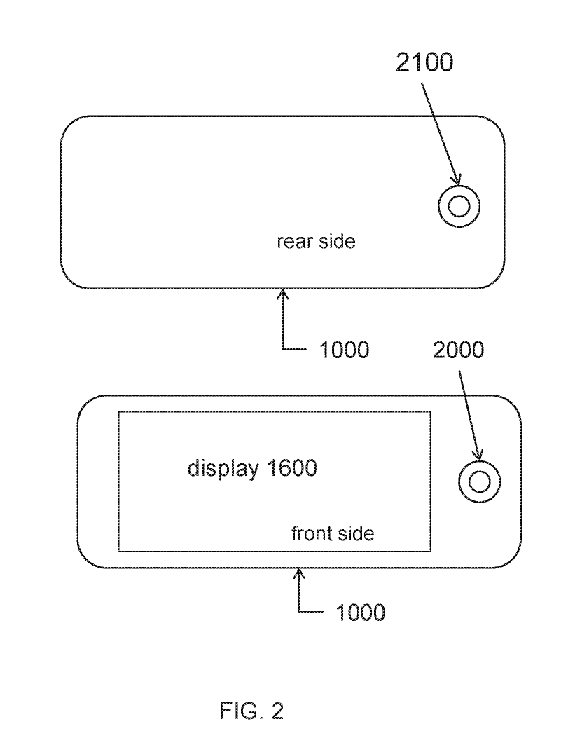

The first image capture module 2000 and the second image capture module 200 are respectively coupled with the control unit 1000. The first image capture module 2000 refers to a front camera and the second image capture module 2100 refers to a rear camera. Alternatively, the first image capture module 2000 refers to a rear camera and the second image capture module 2100 refers to a front camera. The front camera is set on the surface which includes a display, and the rear surface is opposite side to the front surface. The rear camera is set on the rear surface. A self-portrait photograph generation module 2200 is coupled to aforementioned control unit 1000. The first and second image capture module includes at least one image capture elements as shown in FIG. 2. The image capture elements can be CMOS, or CCD. After two captured images are captured and stored, the images can be processed by the self-portrait photograph generation module 2200 to generate merged image, alternatively, the image can be used as photo sticker, wallpaper, desktop, stereo images used for the address book, etc.

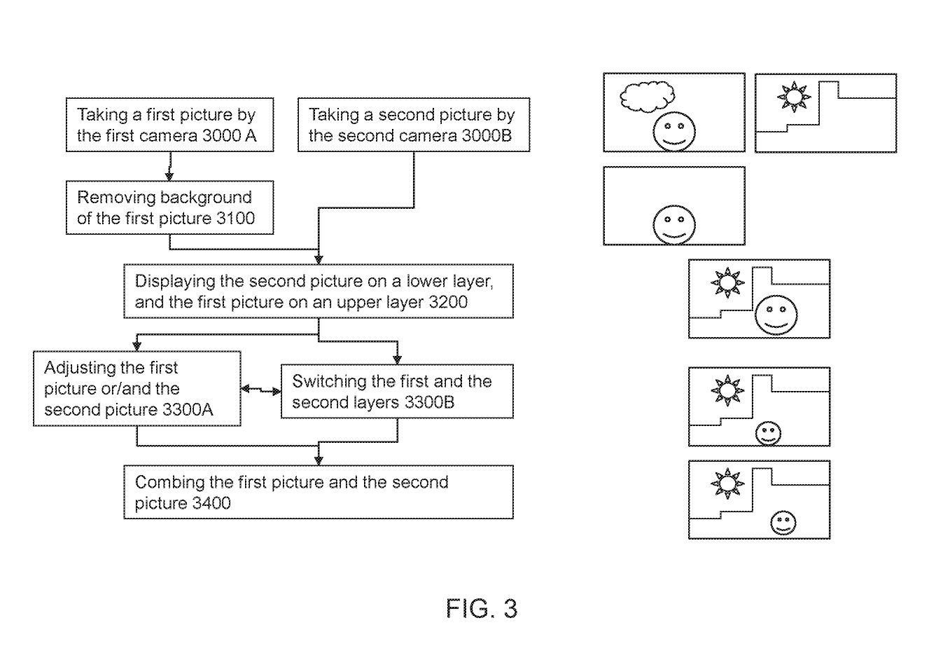

Please refer to FIG. 3, after the self-portrait photograph generating module is initiated, the first camera and the second camera are employed to take a front image and a rear image by the first camera and the second camera, respectively, when the user take a picture. For example, the self-portrait photograph can be taken by the font camera and the scene in front of the user may be taken by the rear image. In one preferred embodiment, the first and the second camera are simultaneously activated to take pictures in step 3000A and 3000B. In one example, the first picture is taken by the front camera and the second picture is taken by the rear camera. The background of the first picture is removed or filter by the self-portrait photograph generating module 2200 in step 3100, remaining the desired portion such as the user oneself image.

The next step 3200 is to display the second picture on a lower layer and the first picture on an upper layer on the display by the self-portrait photograph generating module 2200. At the stage, the two pictures are located on different layer, and they can be adjusted without interrupting another picture on the different layer as shown in step 3300A. The adjusting process may include size enlarging, squeezing, image rotating, translating, swapping left and right, trimming, fading, blurring, smoothing, noise reduction, and so on. The layers may be switched by the self-portrait photograph generating module 2200 in step 3300B. The original lower layer becomes upper layer, and the original upper layer becomes lower layer. The layers concept is similar with the Photoshop layer which is employed to merge different images with layer masks. In series on layers, it allows the user align and distribute layers in a document using the Move Tool and some handy options in the Options Bar. The first picture is combined with the second picture in step 3400.

The image data captured by the first and the second image capture device 2000, 2100 can be merged, thereby generating self-portrait photograph with desired background, followed by displaying on the display. For example, the user can obtain the self-image with the background he chosen and takes his self-image and the desired background by the first and the second camera 2000, 2100. By aforementioned features, aspects, teaching, and photograph imaging theory, users are able to see the self-image and the scene in front of the user on the display when making a photo. Aforementioned self-portrait photograph generation module can be software, firmware, or computer readable commands for displaying images in the digital camera.

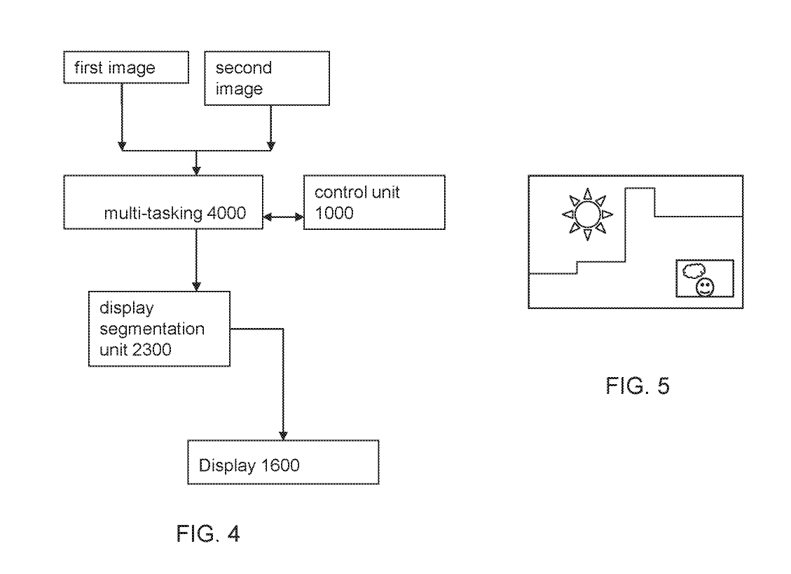

The portable communication device 1000 comprises an display segmentation unit 2300 coupled to the control unit 1000 for simultaneously dividing the display areas on the display for display multiple images including the first image and the second image when capturing the pictures by the first and the second cameras. The capture images before taken will be assigned to the divided display areas which may be separated, overlapped, or partially overlapped. Referred to FIG. 4, a plurality of input images are transferred to multi-tasking module 4000 for processing received images form a plurality of cameras. Before the image data signals transmitted to the display, aforementioned images are previously processed by the image segmentation unit 2300. The multitasking module 4000 refers to a method where multiple tasks (also known as processes) share common processing resources such as a CPU. Multitasking solves the one process one task problem by scheduling which task may be the one running at any given time, and when another waiting task gets a turn. The multi-tasking allow reassign the control unit from one task to another different task to achieve parallelism or context switches. Thus, the different task multi-tasking module may reassign the control unit to switch from one process to another different process to facility context switches.

Another alternative method is similar with the above aforementioned method, most of the step and procedures are the same, some of them are omitted. The selfie or the self-portrait photograph is combined with the picture to generate a picture in picture type image, as shown in FIG. 5. It may indicate who takes the picture. The first picture may refer to a copy-right indication. The second picture is generated with the copy-right indication after merging the first picture and the second picture. As the same with the above embodiment, the self-portrait photograph taken by the front camera is floating and movable on the second picture before merging. The user may move the floating self-portrait photograph to desired location over the second picture.

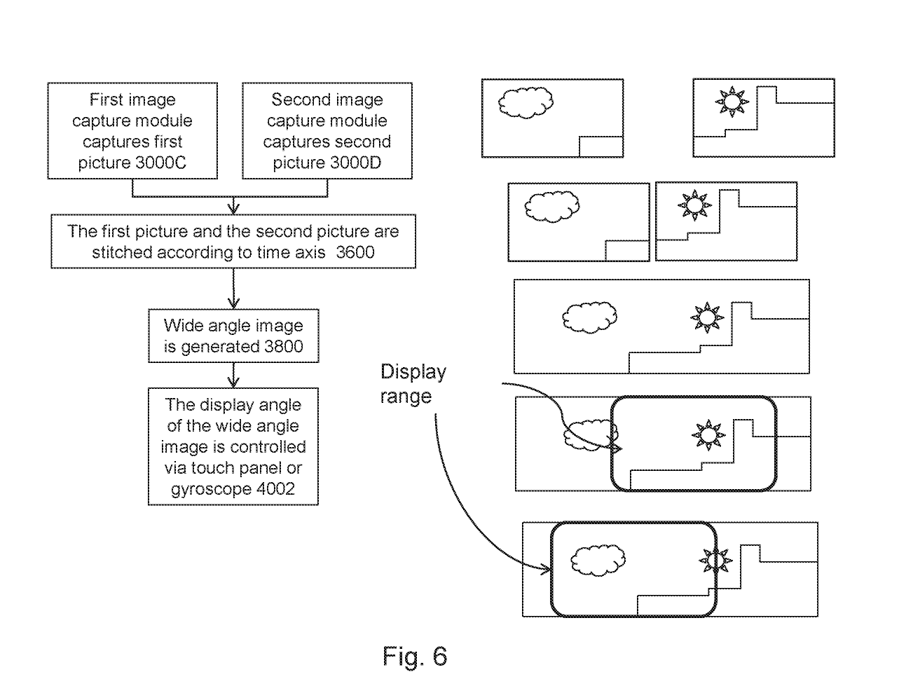

A wide angle video or image may be formed by utilizing smart phone or tablet PC through employing part of or all of the aforementioned technical features. In this embodiment, a wide angle image generating module 2250 may be included with reference to FIG. 1. Please refer to FIG. 6. The wide angle image generating module 2250 may be actuated. At this time, the first image capture module 2000 and the second image capture module 2100 capture a front image and a rear image respectively at the same time (simultaneously). In a preferred embodiment, in step 3000C and step 3000D, the first image capture module 2000 and the second image capture module 2100 are actuated at the same time. In one example, the first image capture module 2000 obtains the first picture(s) by continuously capturing images while the second image capture module 2100 obtains the second picture. In step 3600, the first image(s) are stitched with the second image according to the time axis via the computation by the control unit and the execution of stitching module 2255 of the wide angle image generating module 2250. The overlapped portions may be removed or filtered out. Subsequently, the wide angle image may be generated, which includes the time axis information and the angle information. The user may control the display angle of the wide angle image through the touch panel (display) 1600 or the gyroscope 2300 in step 4002.

The image data captured by the first image capture module 2000 and the second image capture module 2100 may be combined or stitched to generate the desirable wide view angle images or videos, so as to be displayed on the display. The wide angle image generating module 2250 mentioned above may be software, firmware or computer readable instructions to display the images in the digital camera. Furthermore, the first image capture module 2000 and the second image capture module 2100 may have fisheye lens to enhance the angle of capturing.

Aforementioned description is to illustrate purposes of the present invention, technical characteristics to achieve the purposes, and the advantages brought from the technical characteristics, and so on. And the present invention can be further understood by the following description of the preferred embodiment accompanying with the claim.

What is claimed is:

1. A portable device, comprising:
a control unit;
a first and a second image capturing device coupled to said control unit;
a wide angle image generating module coupled to said control unit to activate said first and said second image capturing device, simultaneously for taking a first picture by said first image capturing device and a second picture by said second image capturing device respectively;
a stitching module coupled to said control unit to combine said first picture and said second picture to form a wide view angle image; and
a display coupled to said control unit for displaying said wide view angle image.

2. The portable device according to claim 1, wherein said first picture and said second picture are stitched according to time axis to form said wide view angle image.

3. The portable device according to claim 1, wherein said wide view angle image includes time information.

4. The portable device according to claim 1, wherein said wide view angle image includes angle information.

5. The portable device according to claim 1, further comprising controlling display angle of said wide view angle image via touch display.

6. The portable device according to claim 1, further comprising controlling display angle of said wide view angle image by a gyroscope.

7. The portable device according to claim 1, wherein said first image capture module includes fisheye lens.

8. The portable device according to claim 1, wherein said second image capture module includes fisheye lens.

9. A portable device, comprising:
a control unit;
a front and a rear image capturing device coupled to said control unit;
a wide angle image generating module coupled to said control unit to activate said front and said rear image capturing device, simultaneously, for taking a first picture by said front image capturing device and a second picture by said rear image capturing device respectively;
a stitching module coupled to said control unit to combine said first picture and said second picture to form a wide view angle image;
a display coupled to said control unit for displaying said wide view angle image; and
a gyroscope coupled to said control unit for controlling a display angle of said wide view angle image.

10. The portable device according to claim 9, wherein said first picture and said second picture are stitched according to time axis to form said wide view angle image.

11. The portable device according to claim 9, wherein said wide view angle image includes time information.

12. The portable device according to claim 9, wherein said wide view angle image includes angle information.

13. The portable device according to claim 9, further comprising controlling display angle of said wide view angle image via touch display.

14. The portable device according to claim 9, wherein said front image capture module includes fisheye lens.

15. The portable device according to claim 9, wherein said rear image capture module includes fisheye lens.

16. A portable device, comprising:
a control unit;
a first and a second image capturing device coupled to said control unit;
a wide angle image generating module coupled to said control unit to activate said first and said second image capturing device, simultaneously, for taking a first picture by said first image capturing device and a second picture by said second image capturing device respectively;
a stitching module coupled to said control unit to combine said first picture and said second picture to form a wide view angle image; and
a display coupled to said control unit for displaying said wide view angle image, wherein said wide view angle image includes angle information, time information or the combination thereof.

17. The portable device according to claim 16, further comprising controlling display angle of said wide view angle image via touch display.

18. The portable device according to claim 16, further comprising controlling display angle of said wide view angle image by a gyroscope.

19. The portable device according to claim 16, wherein said first image capture module includes fisheye lens.

20. The portable device according to claim 16, wherein said second image capture module includes fisheye lens.
